(19) United States
(12) Patent Application Publication
(10) Pub. No.: US 2011/0293952 A1
(43) Pub. Date: Dec. 1, 2011

(54) COMPOSITION AND PROCESS FOR SEALING THE SURFACE OF BUILDING MATERIALS

(76) Inventor: Luca Bonato, Milan (IT)

(21) Appl. No.: 13/138,326

(22) PCT Filed: Feb. 4, 2009
(86) PCT No.: PCT/IT2009/000030

§ 371 Date: Aug. 2, 2011

(51) Int. Cl. C09D 1/04; B32B 27/06; B05D 3/06; B82Y 30/00

(52) U.S. Cl. 428/447; 106/632; 106/634; 427/557; 977/773

(57) ABSTRACT

A composition is described, for filling the pores existing in the surfaces of coatings used in architecture, both for exteriors and for interiors, whose function is protecting the above surfaces against stains, comprising: sodium silicate to form a film; natural or synthetic mineral nano-charges to reduce, when drying, the shrinkage of a material deposited inside the pores; glycerine to slow-down drying; water as solvent; surface-active material to make it easier to wet the surface pores; dispersant to stabilise the nano-particles and to avoid their agglomeration and following sedimentation.

The present invention refers to the process and the materials used for sealing the surface porosity of a wide group of building materials used as architectural coatings, such as, for example, natural stones (mainly marble and granite), ceramic tiles, composite materials with polymeric matrix, etc.

The prior art is given by processes and materials for sealing the pores by using water as solvent and having sodium silicate as common component, added to microscopic mineral charges and other additives for improving fluidity and retarding the drying.

Among the results that can be obtained by using materials based on water and sodium silicate for sealing the pores, prevalence is given to the possibility of obtaining surfaces whose appearance is similar to the one of the substrates on which they operate, with the advantages of being able to avoid, through the use, the problems of degrading the aesthetic appearance, and making the cleaning of the treated surface easier.

The methods for preparing, applying and heat-treating (and/or pressure-treating) on architectural coatings, necessary for obtaining the above stain-resisting surfaces also fall within the scope of the present invention.

It is known to seal the surface porosity of materials on surfaces of a very different nature, and also with very different purposes. In some inventions, even suspensions with sub-microscopic charges, such as colloidal silica or alumina, have been used, with the purpose of obtaining stain-resisting coatings on any type of porous surface (U.S. Pat. No. 2,877,142, U.S. Pat. No. 2,978,349 and U.S. Pat. No. 3,033,699). These inventions allow sealing the surface porosity, however resulting weak and fragile. Much more recently, within architectural coatings (ceramic tiles and natural stones), the efforts for sealing the surface porosity have been devoted, almost exclusively, to the use of organic polymers with different nature or subjected to cross-linking in many different forms. In facts, patents are known that deal with: the use of silicone or derived materials having further a high hydro-preventing capability (U.S. Pat. No. 5,356,716, U.S. Pat. No. 6,432,181 and U.S. Pat. No. 6,676,733); epoxy resins (U.S. Pat. No. 6,358,564), urethanes or polyurethane cross-linkable against humidity (U.S. Pat. No. 4,810,533, WO-A-92/13026 e U.S. Pat. No. 6,572,927); photo-cross-linkable resins or polymers (U.S. Pat. No. 6,296,902, WO-A-04/031103, WO-A-03/008506A2, ES-A-2208103).

The limits dealing with the coatings described in the above-mentioned patents are: a lower resistance to abrasions; an environmental impact associated with handling and use of solvents and organic compounds.

Regarding the use of sealants of an organic nature, the related patents are much less than those of the previous case, since their application is more oriented towards highly technologic ceramic materials with different functions from those of building materials. For example, coatings for thermal barriers (U.S. Pat. No. 6,413,578) or ceramic coating materials for space vehicles (U.S. Pat. No. 9,809,80).

The sodium silicate, commonly called “water glass”, has been widely used in several industrial sectors, such as:

basic material for producing amorphous silica and silica-gel;

for checking alkalinity and for inhibiting corrosion;

stabiliser in whitening with hydrogen dioxide;

agglomerating agent in foundry sands or electrode sands;

accelerator in the solidification of cements and refractory masses.

In the ceramic industry, it is used as dispersant of clayish suspensions or as linking agent of crude ceramic products.

As regards the film-generating properties of the sodium silicate, this latter one is widely used as:

economic coating for protecting metals (JP-A-2000176374);

linking material in coatings for scagliolas (DE-A-10056066);

protection of glass panels (CH-A-691674) or coating resisting to water and oxidation on any type of surface (JP-A-7034029).

In spite of this, it has never been used on the materials described in the present invention with the purpose of sealing the surface porosity and for making the surface highly resistant to stains.

It must be stated that the use of sodium silicate coupled with mineral nano-charges in the form of a suspension in the starting composition makes the sealing action still more efficient, and consequently improves the resistance to alones or stains.

The widespread use of sodium silicate in different technologic fields suggests to use it for sealing the porosity of materials for buildings used as coatings (natural stones, ceramic tiles, composite materials with polymeric matrix) and to prevent them from staining. In particular, the intrinsic characteristics of sodium silicate, namely quickly forming a glass film, cohesion and resistance to chemical etching, help decreasing the wear of treated surfaces.

The above and other objects and advantages of the invention, as will appear from the following description, are obtained with a composition and a process for sealing the surface of building materials, as described in the respective independent claims. Preferred embodiments and non-trivial variations of the present invention are the subject matter of the dependent claims.

The present invention will be better described by some preferred embodiments thereof, provided as a non-limiting example, with reference to the enclosed drawings, in which:

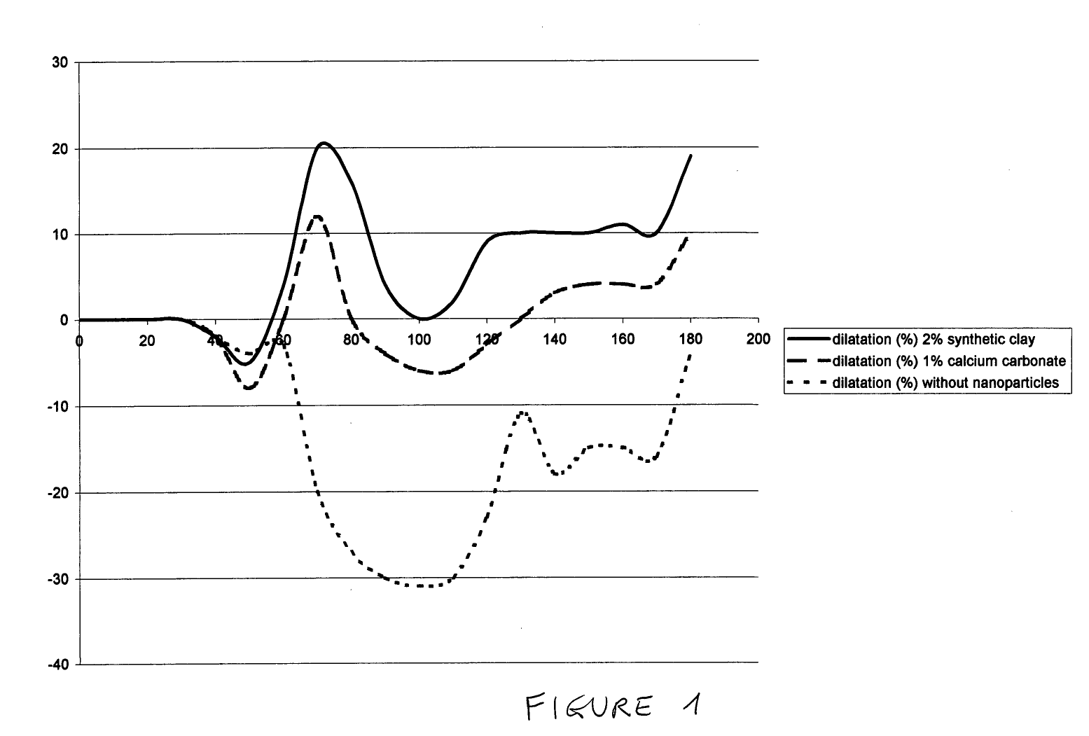

FIG. 1 is a graph that shows shrinkage or dilatation of various aqueous suspensions of sodium silicate and nano-particles when drying;

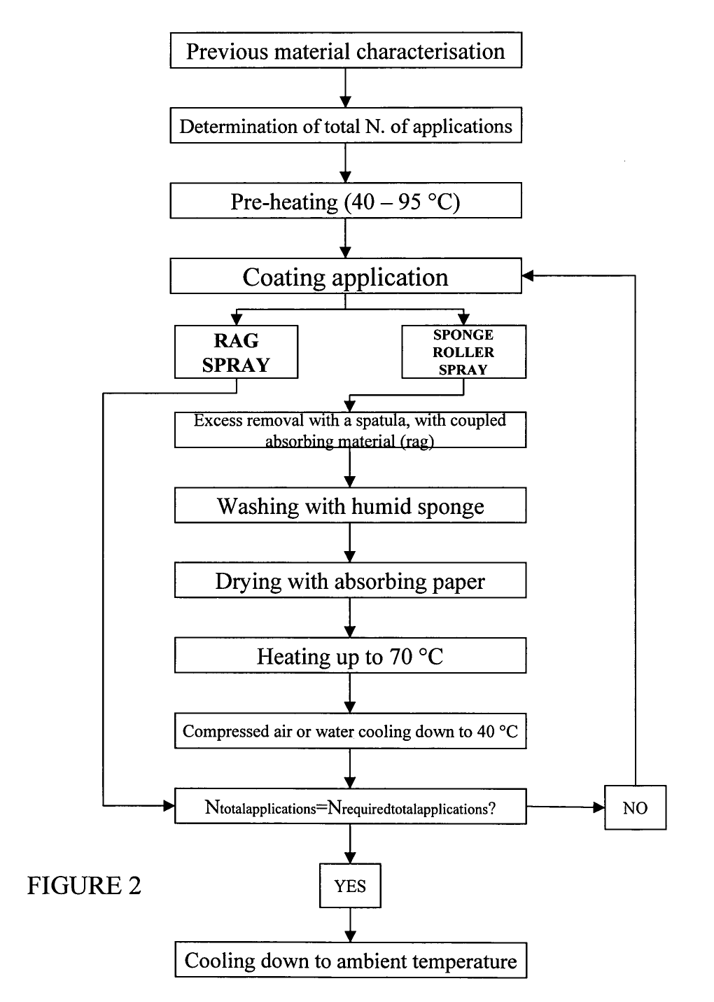

FIG. 2 is a flow diagram of the application process.

The compositions of inorganic suspensions formulated in the present invention allow sealing the porosity of a wide variety of architectural coatings, for example natural stones, ceramic tiles or composite materials with polymeric matrix, avoiding problems related to retaining dirt in the surfaces, almost without changing the appearance of treated substrates. It is then necessary to add thereto a resistance to abrasion and atmospheric agents, that is greater than the resistance of other already existing products, for example silicone or photo-crosslinkable resins.

The resistance to stains can be demonstrated by applying the suspension on part of the architectural coating sample, and leaving the remaining surface without treatment. When the whole surface is stained with a fountain pen with indelible ink and then it is cleaned after 5 minutes, dirt remains on the non-treated part, while at first sight it cannot be perceived in the part subjected to treatment.

Sodium silicate solutions are prepared in an aqueous base, the hardness of used water not changing the results. The solid nature of the components is reduced to a minimum. The total mass fraction of solids in the prepared solutions, in fact, oscillates between 10% and 20%, the remaining 80-90% being water. This act results in a low environmental impact.

Sodium silicate is then handled in the form of an aqueous solution. There are different solutions of sodium silicate commercially available with different percentages of Si0₂ and Na₂O. The most commonly used one has a percentage of 25.5-28.5% of Si0₂ and 7.5-8.5% of Na₂O.

However, the problem is given by the difficulty of applying an aqueous solution of sodium silicate in the above-listed percentages on architectural substrates; in fact, high viscosity (m165 cP) and surface tension (m75 nN/m) make it difficult for it to slide. Through the use of a surface-active agent, preferably a non-ionic one, this problem is for its major part solved.

By adding small amounts of mineral charges, the suspension penetration into the pores improves, viscosity decreases, fluidity increases and shrinkage within the pores decreases. Mineral charges can be of different types; good results have been obtained by using clays and other natural or synthetic silico-aluminates (bentonite, hectorite, sepiolite), precipitated calcium carbonate, silica or colloidal alumina.

To be able to avoid agglomeration and sedimentation of nano-particles, it is necessary to add a dispersant whose charges, added in a very small percentage in the aqueous suspension, make the resulting mixture expand, releasing water in a determined range of temperatures. This phenomenon can be appreciated in FIG. 1, in which sodium silicate suspensions with 20% in weight are compared with nano-particles of a different nature. As can be observed, in the range of temperatures included between 60 and 80° C., these suspensions are subjected to a great dilatation, reaching their maximum value at about 70° C.

The formulation of the composition of the invention is completed with a small amount of glycerine, to be able to slow down the mixture drying and to make it easier to remove the excess material laid on the surface to be treated.

The components of the above composition, at ambient temperature, are mixed without difficulty. In order to be able to better disaggregate and disperse the particles, it is advisable to shake the resulting mixture in an ultrasound bath or with a high intensity, mechanical shaker. It could be enough to shake for 5 minutes.

The optimisation of sodium silicate suspensions brings about the following composition ranges, all referred to the total suspension weight:

a) Water in a proportion between 80% and 90%.
b) Sodium silicate in a proportion between 8% and 20%. Part of water is already added by using a solution.
C) Mineral charges in nanometric sizes in a proportion between 10% and 4%.
d) Glycerine in a proportion between 0% and 5%.
e) Anionic or non-ionic surface-active material, in a proportion between 0% and 0.1%. Under these conditions, it is not necessary to use any type of foam-preventing agent.
f) Dispersant in a proportion between 0% and 0.1%.

These suspensions, with a total mass fraction of solids equal to 20%, have a viscosity lower than 110 cP, and a surface tension lower than 25 mN/m. This rheologic behaviour makes it possible to apply them by means of several techniques. Sodium silicate suspensions can be applied by using a roller, a spatula, a sponge, a cloth, by spraying. Each one of these methods makes it possible to homogeneously distribute the suspension on the whole surface of the treated material.

FIG. 2 shows a flow diagram of the process for applying the suspensions.

The application can be performed at ambient temperature or by previously heating the material by means of infrared-ray lamps or by means of any other heating method that makes it possible to heat the surface of the material to be treated. This heat treatment favours the dilatation of the material pores and allows reducing and controlling the drying time. A heating around 40° C. is quickly obtained preventing the applied coating, being dried in its surface, from reaching a great shrinkage. Instead, a temperature higher than 60° C. generates an almost instantaneous drying.

The coating quality is kept at an optimum level by replacing the heating stage at 70° and the cooling stage with compressed air till 40° C. with a stage that provides for the coating application under a vacuum atmosphere.

If the objective is sealing the pores only, it is necessary to avoid that a layer of material is formed on the surface. The removal of the excess coating is the highest difficulty in the process. In fact, if the removal occurs by absorption, for example through a rag, this latter one gets impregnated and absorbs almost all the applied suspension, impairing the resistance to stains that results scarce. It is not even possible to apply the composition and remove the excess when the composition has hardened, since the abrasion resistance has increased.

The solution is: applying a layer of coating; remove the excessive amount after a certain “critical time” whose value depends on the support temperature.

If the support temperature is 40° C., the critical time is about 30 seconds. During this interval, it is necessary to pay attention to avoid that the coating does not get dried around the piece, forming crusts that afterwards could not be removed any more. This inconvenience is avoided by applying a bit more suspension in the areas in which an excessive shrinkage is observed. Then, it is removed with a spatula coated with a rag, and it is dried with an absorbing material, for example paper.

Drying of the material deposited in the pores can be performed again at ambient temperature or by means of a heat treatment that accelerates the process.

FIG. 1 shows that the optimum drying range is approximately between 60° C. and 80° C., reaching a maximum dilatation at about 70° C. The final treatment is advisable not only for better sealing the porosity, but also for minimising the appearance change of the surface with respect to the original material. This process ends with cooling the treated substrates using compressed air or water. The dry sealing material does not generate cracks due to the thermal head, and this makes it available to choose any one of the two methods.

If, on the contrary, it is desired to deposit a coating film, the process gets highly simplified. It will be enough to pre-heat the support at 90-95° C. and then apply the suspension with a cloth. In such a way, the coating loses all its water instantaneously, remaining adherent to the surface. Heating before the application further allows depositing a layer with greater thickness and homogeneity.

The following application of a silicone-based emulsion modifies the contact angle value of the treated surface, improving the oil/water-repellence characteristics of the surface itself.

One or more applications will be necessary, depending on the substrate to be treated. The open porosity of granites, of composite materials and of stoneware, is sealed with a single application. Instead, marbles or some types of porcelain-coated stoneware can require two or more applications.

1. A composition for filling surface pores that exist on surfaces of coatings used in architecture, both for exteriors and for interiors, whose function is protecting the surfaces against stains, the composition comprising:
a. water as a solvent, water being in the range included between 80% and 90% in weight with respect to a final composition;
b. sodium silicate to form a film sodium silicate being in a range included between 7.98% and 17.98% in weight with respect to the final composition;
wherein the composition further comprises:
c. natural or synthetic mineral nanometer-sized charges to reduce, when drying, a shrinkage of a material deposited inside the pores;
d. glycerine to slow down the drying;
e. surface-active material to make it easier for the composition to slide onto the surface pores by wetting the surface pores;
f. dispersant to stabilise the nanometer-sized charges and to avoid the agglomeration and following sedimentation of the nanometer-sized charges.

2. The composition of claim 1, wherein component (b) is introduced as an aqueous solution, with a percentage of active substance that is included between 25.5% and 28.5% in weight of Si0₂ and between 7.5% and 8.5% in weight of Na₂O with respect to the total composition.

3. The composition of claim 1, wherein component (c) is chosen among one or more of the following compounds: sodium bentonite, calcium bentonite, sepiolite, hectorite, ultra fine precipitated calcium carbonate, colloidal silica and colloidal alumina.

4. The composition of claim 1 wherein the proportion of component (c) is included between 1% and 4% in weight with respect to the final composition.

5. The composition of claim 1, wherein the proportion of component (d) is included between 0% 1% and 5% in weight with respect to the final composition.

6. The composition of claim 1, wherein component (e) is in a proportion between 0.01% and 0.1% in weight with respect to the final composition.

7. The composition of claim 1, wherein component (f) is in a proportion between 0.01% and 0.1% in weight with respect to the final composition.

8. (canceled)

9. A process for placing the composition of claim 1 in surface pores existing in the surface of coatings used in architecture, the process comprising the following steps:
a. heating, by means of infrared-ray lamps, the surface to be treated before applying the composition in order to make it easier to fill the pores;
b. treating, in an environment with controlled vacuum atmosphere, the surface to be treated after applying the composition to make it easier to cross-link the composition through solvent evaporation;
c. removing an excess composition;
d. applying a silicone-base emulsion to increase a oil/water-repellence capability of the surface; and
e. cooling the treated surface, by means of air or water.

10. An architectural piece protected with the composition of claim 1, performing the process according to claim 9.

11. An architectural piece protected with the composition of claim 1, performing the process according to claim 9.

12. The process of claim 9, wherein step b. is replaced by the following step:
b. heating, by means of infrared-ray lamps, the surface to be treated after applying the composition to make it easier to cross-link the composition through solvent evaporation.
